(19) United States
(12) Patent Application Publication
(10) Pub. No.: US 2021/0036844 A1
(43) Pub. Date: Feb. 4, 2021

(54) RECEPTION APPARATUS, INFORMATION PROCESSING SYSTEM, AND RECEPTION METHOD

(71) Applicant: FUMIHIRO UMETSU, Kanagawa (JP)

(72) Inventor: FUMIHIRO UMETSU, Kanagawa (JP)

(73) Assignee: Ricoh Company, Ltd., Tokyo (JP)

(21) Appl. No.: 16/921,109

(22) Filed: Jul. 6, 2020

(30) Foreign Application Priority Data
Jul. 31, 2019 (JP) 2019-141609

(51) Int. Cl. H04L 9/08; H04L 12/58; H04L 9/32

(52) U.S. Cl. CPC H04L 9/0825; H04L 9/32; H04L 51/18; H04L 51/22

(57) ABSTRACT

A reception apparatus, an information processing system, and a reception method. The reception apparatus receives an encrypted email, stores, in the at least one memory, a part of a private key in association with identification information of a destination user of the email, acquires a remainder of the private key from one or more other reception apparatuses that store the remainder of the private key, restores the private key from the remainder of the private key and the stored part of the private key, decrypts the email with the restored private key, and outputs the decrypted email.

### CROSS-REFERENCE TO RELATED APPLICATIONS

This patent application is based on and claims priority pursuant to 35 U.S.C. § 119(a) to Japanese Patent Application No. 2019-141609, filed on Jul. 31, 2019, in the Japan Patent Office, the entire disclosure of which is hereby incorporated by reference herein.

### BACKGROUND

### Technical Field

The present disclosure relates to a reception apparatus, an information processing system, and a reception method.

### Background Art

A transmission apparatus that transmits an internet fax and a reception apparatus that receives the internet fax are known. The internet fax is advantageous in communication cost because messages are sent and received through the internet without using a telephone line. However, since the internet fax sends messages over the internet, it is recommended to encrypt messages when sending confidential information.

In internet fax, image data corresponding to a message is sent as an attachment file of an email. However, since the email is in a multipurpose internet mail extensions (MIME) format, secure multipurpose internet mail extensions (S/MIME) may be used for encryption.

### SUMMARY

Embodiments of the present disclosure describe a reception apparatus, an information processing system, and a reception method. The reception apparatus receives an encrypted email, stores, in the at least one memory, a part of a private key in association with identification information of a destination user of the email, acquires a remainder of the private key from one or more other reception apparatuses that store the remainder of the private key, restores the private key from the remainder of the private key and the stored part of the private key, decrypts the email with the restored private key, and outputs the decrypted email.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating an outline of an operation when an information processing system receives an internet fax according to an embodiment;

FIG. 2 is a diagram illustrating an example of the information processing system;

FIG. 3 is a diagram illustrating an example of a hardware configuration of a mail server;

FIG. 4 is a diagram illustrating an example of a hardware configuration of a transmission apparatus or a reception apparatus;

FIG. 5 is a block diagram illustrating an example of a functional configuration of the transmission apparatus and the reception apparatus included in the information processing system;

FIG. 6 is a diagram illustrating an outline of encryption and decryption processing by S/MIME according to an embodiment;

FIG. 7 is a sequence diagram illustrating an example of a process for registering a receiver's private key and public key in the reception apparatus;

FIG. 8 is a diagram illustrating an example of a key storage apparatus setting screen;

FIG. 9 is a diagram illustrating an example of a message screen;

FIG. 10 is a diagram illustrating an example of a registration completion screen; and

FIG. 11 is a sequence diagram illustrating a process executed by the reception apparatus when receiving an email encrypted and transmitted by the internet fax according to an embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Hereinafter, a description is given of embodiments of a reception apparatus and a reception method performed by the reception apparatus with reference to the drawings.

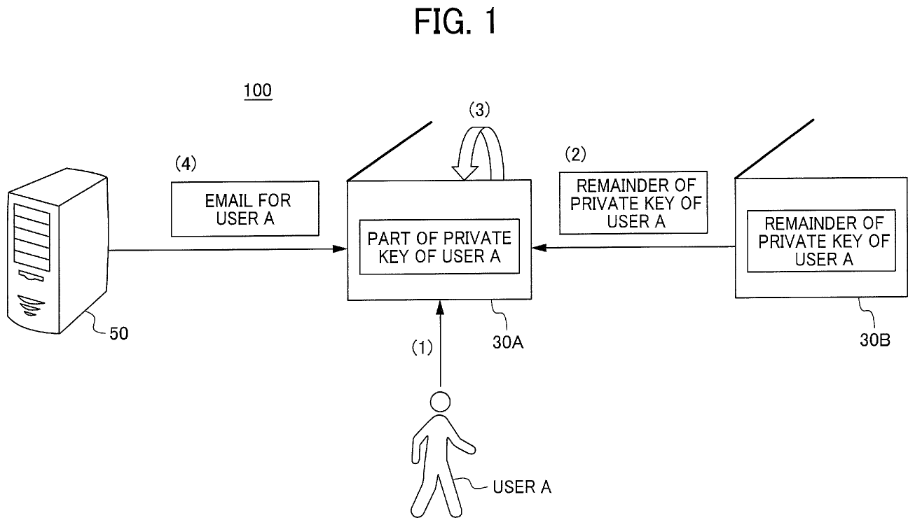

FIG. 1 is a diagram illustrating an outline of an operation when an information processing system 100 receives an internet fax according to an embodiment. In the present embodiment, an administrator or the like divides a private key of a receiver in advance and stores each of the divided keys separately in two or more reception apparatuses 30. When the reception apparatus 30 receives an internet fax, the private keys of the receiver are collected from the reception apparatuses 30 at the distribution destinations and restored and the image data (a file attached to an email) transmitted by the internet fax is decrypted.

(1) User A logs in to the reception apparatus 30A.

(2) When user A receives and tries to print the internet fax (email) addressed to user A, the reception apparatus 30A identifies the reception apparatus 30B that stores the private key associated with user A and acquires “remainder of user A's private key” from the reception apparatus 30B.

(3) The reception apparatus 30A restores user A's private key from “a part of user A's private key” stored in the reception apparatus 30A and “the remainder of user A's private key”.

(4) The reception apparatus 30A acquires the email addressed to user A from the mail server 50 and decrypts the image data attached to the email according to S/MIME.

As described above, even if the reception apparatus 30 is shared by a plurality of users, since the reception apparatus 30 stores the private key in a distributed manner, the private key of the receiver is safely stored at a low cost. Therefore, it is possible to reduce the cost and receive the email encrypted by S/MIME.

Encryption refers to a conversion of information understandable only by concerned parties. Encrypted information may be compressed if the information is confidential.

The private key is a key that should be kept secret by the owner of the key in public key cryptography. The key is information, not a mechanical object.

Restoring the private key refers to creating the original private key, which may be referred to as reproduction. As long as the original private key is obtained, the restoration method does not matter. A part or the remainder of the private key may be converted by a function or the like, and there may be a step of returning the original by an inverse function.

Decryption refers to restoring original data from encrypted data. Plain text data may be created.

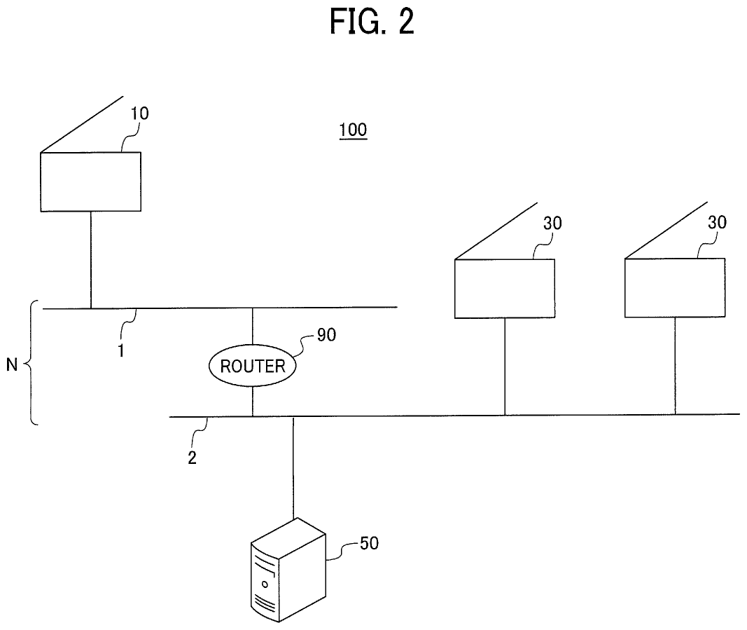

FIG. 2 is a diagram illustrating an example of an overall configuration of the information processing system 100. The information processing system 100 includes one or more transmission apparatuses 10, a mail server 50, and two or more reception apparatuses 30A and 30B that are communicably connected through a network N. FIG. 2 only illustrates apparatuses mainly used in the description of the present embodiment, and apparatuses other than those illustrated (for example, a firewall) may be included. Hereinafter, any reception apparatus of the reception apparatuses 30A and 30B is referred to as a “reception apparatus 30”.

The network N includes a network 1 to which the transmission apparatus 10 is connected, and a network 2 to which the reception apparatus 30A and the reception apparatus 30B are connected. The configuration of the illustrated network is merely an example. For example, the mail server 50 may be connected to the network 1 or may be connected to a network different from the networks 1 and 2. The number of routers 90 is not limited to one, and the networks 1 and 2 may be connected through a plurality of routers 90. Note that a network that can be connected from a computer on a global scale is called the internet, and the network N may include a part of the internet.

The transmission apparatus 10 is an information processing apparatus that transmits the internet fax or the email. Since internet fax sends a message (scanned image data) as an attachment file of an email, the user designates a destination by a mail address at the time of transmission just as with the transmission of the email. An example of transmitting the internet fax is described below, but the private key management method of the present embodiment can be preferably applied to the case of transmitting the email.

The transmission apparatus 10 reads (scans) a document prepared by a sender to generate image data. Therefore, the transmission apparatus 10 preferably includes a scanner function. An apparatus including the scanner function is called a reading apparatus or a scanner. In addition to the scanner function, the apparatus may include a telephone line type facsimile function, a copy function, a printer function, and the like. The apparatus including a plurality of functions as described above is called a multi-function peripheral (product or printer) or an MFP. The transmission apparatus 10 transmits the generated image data to the mail server 50 through the network N.

An apparatus for creating image data may be a digital still camera or a digital video camera. Instead of the transmission apparatus 10 accepting the input of the image data, the transmission apparatus 10 may acquire the image data from the outside. For example, the image data may be read from a storage medium such as a universal serial bus (USB) memory, the image data may be received as a video conference terminal, or handwritten data on an electronic whiteboard may be acquired as the image data. Further, it is possible to transmit image data generated, acquired, or stored by a personal computer (PC).

The reception apparatus 30 includes a function of receiving image data by email. Since it is desired to print the image data attached to the email in the internet fax, it is preferable to include a printer function. An apparatus including the printer function is called a printer, a printing device, or an image forming device. The reception apparatus 30 may include other functions, and the reception apparatus 30 may be the multi-function peripheral or the MFP, like the transmission apparatus 10. The reception apparatus 30 may not include a printer function, and may be the video conference terminal, the electronic whiteboard, the PC, or the like. The reception apparatus 30 receives emails from the mail server 50 through the network N.

The mail server 50 is an email server that provides a function for the reception apparatus to receive email. A protocol called post office protocol (POP) used by the reception apparatus 30 at the time of reception is known. The currently used version is 3 and called POP3. A protocol called internet message access protocol (IMAP) is also known. The difference between the two protocols is the place where the email is saved. In POP3, the receiving terminal side (reception apparatus 30 in this embodiment) receives and saves the email, but in IMAP, the mail server 50 saves the email. In the present embodiment, either protocol may be adopted, but for convenience of explanation, description is given on a premise of POP3.

In the mail server 50, emails transmitted by the transmission apparatus 10 to a send mail transfer protocol (SMTP) server by a protocol called SMTP are accumulated through one or more SMTP servers. The SMTP protocol is a protocol for sending email. The transmission apparatus 10 sends the internet fax (email) to a destination user's mail address. The SMTP server converts the mail address into an internet protocol (IP) address of the POP3 server (mail server 50 of the present embodiment) by a domain name system (DNS) server and transfers the IP address to the POP3 server. Generally, the mail server 50 is reached through some routes. The reception apparatus transmits a user account (user ID and password) to the mail server 50, and when the authentication is successful, acquires the email addressed to the user from the mail server 50.

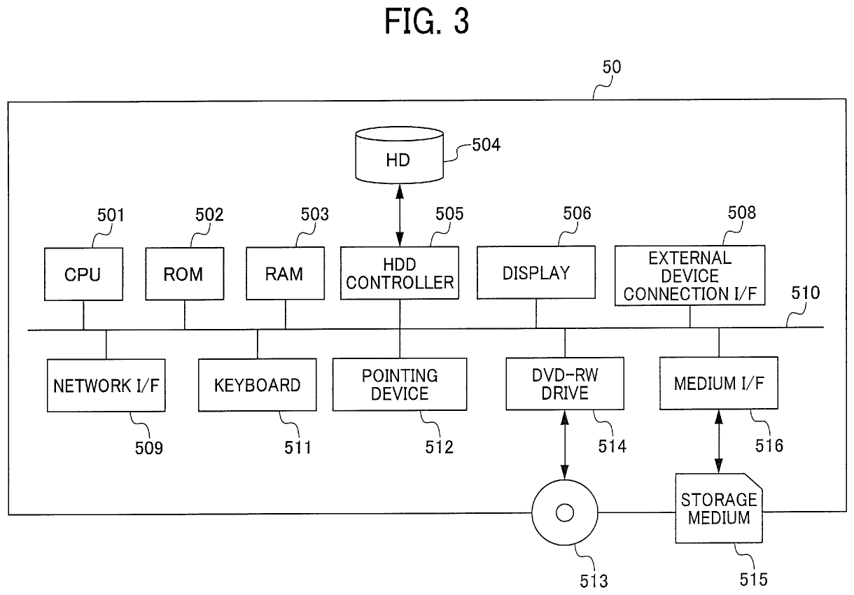

FIG. 3 is a hardware configuration diagram of the mail server 50 according to the embodiment. As illustrated in FIG. 3, the mail server 50 is implemented by a computer including a central processing unit (CPU) 501, a read only memory (ROM) 502, a random access memory (RAM) 503, a hard disk (HD) 504, a hard disk drive (HDD) controller 505, a display 506, an external device connection interface (I/F) 508, network I/F 509, a bus line 510, a keyboard 511, a pointing device 512, a digital versatile disc rewritable (DVD-RW) drive 514 and a medium I/F 516.

Among these elements, the CPU 501 controls entire operation of the mail server 50. The ROM 502 stores a program such as an initial program loader (IPL) used for driving the CPU 501. The RAM 503 is used as a work area for the CPU 501. The HD 504 stores various data such as a control program. The HDD controller 505 controls reading and writing of various data from and to the HD 504 under control of the CPU 501. The display 506 displays various information such as a cursor, menu, window, character, or image. The external device connection I/F 508 is an interface for connecting various external devices. The external device in this case is, for example, a universal serial bus (USB) memory or a printer. The network I/F 509 is an interface for performing data communication using the network N. The bus line 510 is an address bus, a data bus, or the like for electrically connecting each component such as the CPU 501 illustrated in FIG. 3.

The keyboard 511 is an example of an input device provided with a plurality of keys for allowing a user to input characters, numerals, or various instructions. The pointing device 512 is an example of an input device that allows a user to select or execute a specific instruction, select a target for processing, or move a cursor being displayed. The DVD-RW drive 514 reads and writes various data from and to a DVD-RW 513, which is an example of a removable storage medium. The removable storage medium is not limited to the DVD-RW and may be a digital versatile disc-recordable (DVD-R) or the like. The medium I/F 516 controls reading and writing (storing) of data from and to the storage medium 515 such as a flash memory.

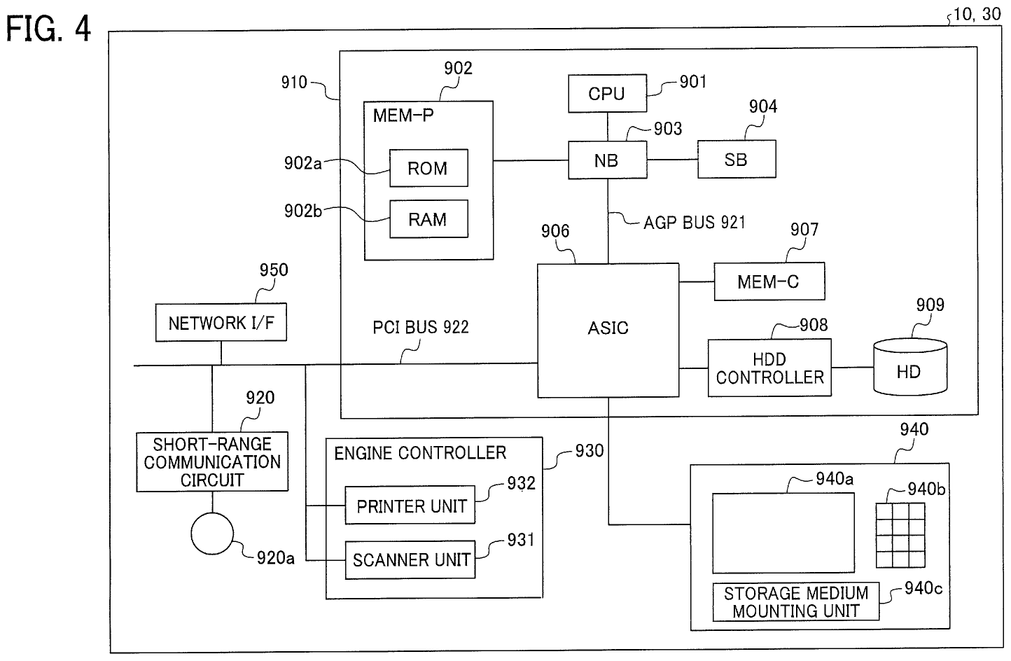

FIG. 4 is a diagram illustrating a hardware configuration of a transmission apparatus 10 or a reception apparatus 30. As illustrated in FIG. 4, the transmission apparatus 10 or the reception apparatus 30 includes a controller 910, a short-range communication circuit 920, an engine controller 930, a control panel 940, and a network IF 950.

The controller 910 includes a CPU 901 as a main processor, a system memory (MEM-P) 902, a north bridge (NB) 903, a south bridge (SB) 904, an Application Specific Integrated Circuit (ASIC) 906, a local memory (MEM-C) 907, an HDD controller 908, and an HD 909 as a storage unit. The NB 903 and the ASIC 906 are connected through an Accelerated Graphics Port (AGP) bus 921.

The CPU 901 is a processor that performs overall control of the transmission apparatus 10 or the reception apparatus 30. The NB 903 connects the CPU 901 with the MEM-P 902, SB 904, and AGP bus 921. The NB 903 includes a memory controller for controlling reading or writing of various data with respect to the MEM-P 902, a Peripheral Component Interconnect (PCI) master, and an AGP target.

The MEM-P 902 includes a ROM 902a as a memory that stores program and data for implementing various functions of the controller 910. The MEM-P 902 further includes a RAM 902b as a memory that deploys the program and data, or as a drawing memory that stores drawing data for printing. The program stored in the ROM 902a may be stored in any computer-readable storage medium, such as a compact disc-read only memory (CD-ROM), compact disc-recordable (CD-R), or digital versatile disc (DVD), in a file format installable or executable by the computer, for distribution.

The SB 904 connects the NB 903 with a peripheral component interconnect (PCI) device or a peripheral device. The ASIC 906 is an integrated circuit (IC) dedicated to an image processing use, and connects the AGP bus 921, a PCI bus 922, the HDD controller 908, and the MEM-C 907. The ASIC 906 includes a PCI target, an AGP master, an arbiter (ARB) as a central processor of the ASIC 906, a memory controller for controlling the MEM-C 907, a plurality of direct memory access controllers (DMACs) capable of converting coordinates of image data with a hardware logic, and a PCI unit that transfers data between a scanner 931 and a printer 932 through the PCI bus 922. The ASIC 906 may be connected to a USB interface, or the Institute of Electrical and Electronics Engineers 1394 (IEEE1394) interface.

The MEM-C 907 is a local memory used as a buffer for image data to be copied or a code buffer. The HD 909 is a storage for storing image data, font data used during printing, and forms. The HDD controller 908 reads or writes various data from or to the HD 909 under control of the CPU 901. The AGP bus 921 is a bus interface for a graphics accelerator card, which has been proposed to accelerate graphics processing. Through directly accessing the MEM-P 902 by high-throughput, speed of the graphics accelerator card is improved.

The short-range communication circuit 920 includes a short-range communication antenna 920a. The short-range communication circuit 920 is a communication circuit that communicates in compliance with the near field communication (NFC), the Bluetooth (registered trademark) and the like.

The engine controller 930 includes a scanner 931 and a printer 932. The control panel 940 includes a display panel 940a and an operation panel 940b. The display panel 940a is implemented by, for example, a touch panel that displays current settings or a selection screen and receives a user input. The operation panel 940b includes a numeric keypad that receives set values of various image forming parameters such as image density parameter and a start key that accepts an instruction for starting copying. The storage medium mounting unit 940c for mounting a storage medium is also provided. The controller 910 controls all operations of the transmission apparatus 10 or the reception apparatus 30. For example, the controller 110 controls drawing, communication, or user inputs to the control panel 940. The scanner 931 or the printer 932 includes an image processing unit such as error diffusion processing and gamma conversion processing.

In response to an instruction to select a specific application through the control panel 940, for example, using a mode switch key, the transmission apparatus 10 or the reception apparatus 30 selectively performs a document box function, a copy function, a print function, and a facsimile function. With selection of the print function, the transmission apparatus 10 or the reception apparatus 30 operates in a print mode. With selection of the facsimile function, the transmission apparatus 10 or the reception apparatus 30 operates in a facsimile mode. When the document box function is selected, the transmission apparatus 10 or the reception apparatus 30 operates in a document box mode to store document data. With selection of the copy function, the transmission apparatus 10 or the reception apparatus 30 operates in a copy mode.

The network I/F 950 is an interface for performing data communication using the network N. The short-range communication circuit 920 and the network I/F 950 are electrically connected to the ASIC 906 through the PCI bus 922.

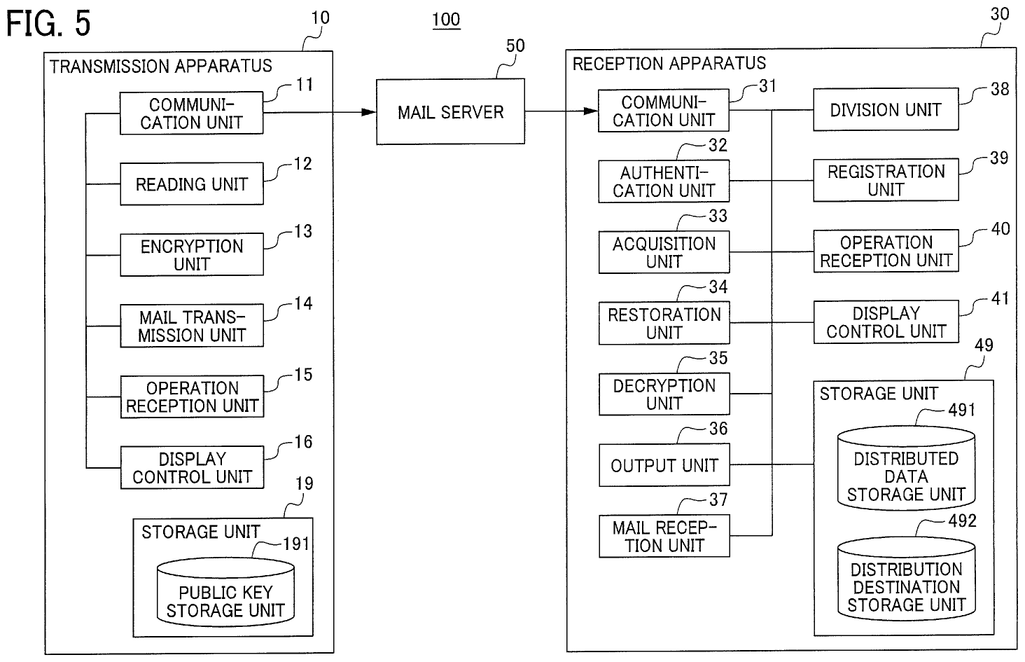

FIG. 5 is a block diagram illustrating an example of a functional configuration of the transmission apparatus 10 and the reception apparatus 30 included in the information processing system 100.

The transmission apparatus 10 includes a communication unit 11, a reading unit 12, an encryption unit 13, a mail transmission unit 14, an operation reception unit 15, and a display control unit 16. These functions of the transmission apparatus 10 are functions or units implemented by the CPU 901 of the transmission apparatus 10 illustrated in FIG. 4 executing the program stored in the HD 909 or the like and controlling the hardware of the transmission apparatus 10.

The communication unit 11 is connected to the network N and transmits and receives various data through the network.

The reading unit 12 optically reads a document placed on exposure glass to generate image data. An automatic document feeder (ADF) may be used.

The encryption unit 13 encrypts image data. It is preferable to perform encryption based on a communication protocol for transmitting the encrypted email, and the encryption unit 13 performs encryption with an encryption algorithm determined by the communication protocol. For example, assume that encryption is performed based on S/MIME. A detailed description is given below.

The mail transmission unit 14 sends the email to the mail server 50. The internet fax may be used for the email, or the email may be directly designated and used. The image data read by the reading unit 12 is attached to the email.

The operation reception unit 15 accepts various operations on the transmission apparatus 10. For example, input of an email address for transmitting image data by internet fax, or a destination user is accepted. Since the mail address and the like are registered in the address book in association with the identification information of the user, the mail address is identified by selecting the user.

The display control unit 16 displays a screen operated by the sender on the control panel 940. In this embodiment, the screen for sending the internet fax is displayed.

Further, the transmission apparatus 10 includes a storage unit 19 implemented by the HD 909, the RAM 902b and the like illustrated in FIG. 4. A public key storage unit 191 is included in the storage unit 19.

TABLE 1

| USER IDENTIFICATION INFORMATION | PUBLIC KEY |
|---|---|
| 001 | ************* |
| 002 | ************* |
| 003 | ************* |
| . . . | . . . |

Table 1 schematically illustrates public keys stored in the public key storage unit 191. The public key storage unit 191 stores the public key of each user in association with the identification information of the user. User identification information is information for identifying a user, such as a name, code, character string, numerical value, or a combination of one or more of these used to uniquely distinguish a particular user from multiple users. For example, a user name or email address may be used.

The public key is used in public key cryptography. The public key cryptosystem is a system for performing cryptographic communication by using a private key and a public key as one set. Data encrypted with the public key can be decrypted only with the private key, and data encrypted with the private key can only be decrypted with the public key. The public key is published on the web and can be obtained by anyone. On the other hand, the private key is kept secret only by one of the receiver and the sender. As described above, the transmission apparatus 10 stores the public key and the reception apparatuses 30 distribute and store the private key.

The reception apparatus 30 includes a communication unit 31, an authentication unit 32, an acquisition unit 33, a restoration unit 34, a decryption unit 35, an output unit 36, a mail reception unit 37, a division unit 38, a registration unit 39, an operation reception unit 40, and a display control unit 41. These functions of the reception apparatus 30 are functions or units implemented by the CPU 901 of the reception apparatus 30 illustrated in FIG. 4 executing a program stored in the HD 909 or the like and controlling the hardware of the reception apparatus 30.

The communication unit 31 is connected to the network N and transmits and receives various data through the network N.

The authentication unit 32 authenticates the user who operates the reception apparatus 30. The user of the present embodiment is a receiver. For example, if a set of user identification information and password is stored in a certain database (DB), the authentication unit 32 determines that the authentication is successful, and if the set of user identification information and password is not stored, the authentication unit 32 determines that the authentication is failed. An external authentication device may be used for authentication. The user is identified by the successful authentication (identification information of the user is revealed). An integrated circuit (IC) card or biometric information may be used for the authentication.

The acquisition unit 33 acquires the distributed data of the logged-in user from another reception apparatus 30. The logged-in user is the receiver of the email (destination of the email). The distribution destination storage unit 492 stores which reception apparatus 30 stores the distributed data of the receiver. The distributed data is obtained by dividing the private key required to decrypt the encrypted email. When one piece of distributed data is stored in the reception apparatus 30 where the user logs in, the distributed data is also acquired.

The restoration unit 34 collects the plurality of pieces of distributed data of the receiver acquired by the acquisition unit 33 into one and restores the private key of the receiver. The restoration method is stored in the distribution destination storage unit 492.

The decryption unit 35 decrypts image data. The decryption unit 35 decrypts with a decryption algorithm determined by the communication protocol used to receive the email. For example, it is assumed that decryption is performed based on S/MIME. A detailed description is given below.

The output unit 36 prints the image data decrypted by the decryption unit 35 on a sheet material such as paper. That is, the image data is outputted or formed into an image.

The mail reception unit 37 receives an email from the mail server 50 according to a mail receiving protocol such as POP3 or IMAP. The email contains image data. The mail reception unit 37 may receive the email without distinguishing between the image data sent by internet fax and the image data sent by email.

The division unit 38 divides the private key into two or more to create n pieces of distributed data. In the present embodiment, description is given assuming that the private key is divided into two. The divided private keys are called distributed data 1 and 2. The divided data may be divided from the center, but the sizes of the distributed data 1 and 2 may be different. Instead of dividing from the center, every other character may be extracted.

The registration unit 39 registers the distributed data 1 divided by the division unit 38 in the distributed data storage unit 491 of its own device and registers the distributed data 2 in the reception apparatus 30 set by the administrator.

The operation reception unit 40 accepts various operations on the reception apparatus 30. For example, a login operation, an operation of receiving and printing an email transmitted by internet fax, and the like.

The display control unit 41 displays a screen operated by the receiver on the control panel 940. In the present embodiment, a screen for receiving the internet fax is displayed.

Further, the reception apparatus 30 includes a storage unit 49 implemented by the HD 909, the RAM 902b and the like illustrated in FIG. 4. A distributed data storage unit 491 and a distribution destination storage unit 492 are included in the storage unit 49.

TABLE 2

| USER IDENTIFICATION INFORMATION | DISTRIBUTED DATA |
|---|---|
| 001 | ************* |
| 002 | ************* |
| 003 | ************* |
| . . . | . . . |

Table 2 schematically illustrates the distributed data stored in the distributed data storage unit 491. The distributed data storage unit 491 stores a part of the distributed data (distributed data 1 or 2) in association with the identification information of the user. The distributed data in Table 2 is a part of the receiver's private key. The part refers to, for example, a first half, a second half, a part obtained by every other character of the private key, or the like. By distributing and storing in this way, the risk of leakage is reduced. The private key can be stored at a low cost by storing the private key in a distributed manner.

TABLE 3

| USER | | | RESTORA- |
|---|---|---|---|
| IDENTIFICATION | DISTRIBUTED | DISTRIBUTED | TION |
| INFORMATION | DATA 1 | DATA 2 | METHOD |
| 001 | RECEPTION | RECEPTION | ADDING |
| | APPARATUS A | APPARATUS B | |
| 002 | RECEPTION | RECEPTION | MERGING |
| | APPARATUS A | APPARATUS B | |
| 003 | RECEPTION | RECEPTION | ADDING |
| | APPARATUS A | APPARATUS B | |
| . . . | . . . | . . . | . . . |

Table 3 schematically illustrates distribution destination information stored in the distribution destination storage unit 492. The distribution destination storage unit 492 stores a plurality of reception apparatuses 30 that store distributed data and a restoration method in association with user identification information. Since the distributed data is distributed to the plurality of reception apparatuses 30, the reception apparatus 30 that stores the distributed data for each of the distributed data 1 and 2 is stored. The distributed data 1 and 2 may be stored in two fixed reception apparatuses 30. In the present embodiment, the reception apparatuses 30 are assumed to be identified by IP addresses, but the reception apparatus 30 may be identified by device names or the like.

The restoration method is a method to restore the distributed data. For example, adding refers to a restoration method in which the distributed data 2 is added after the distributed data 1. For example, when the distributed data 1 is “123” and the distributed data 2 is “456”, the restored private key is “123456”.

The merging is a restoration method in which the distributed data 2 is inserted into the distributed data 1 every other character. For example, when the distributed data 1 is “135” and the distributed data 2 is “246”, the restored private key is “123456”.

The restoration method is not limited to the methods described above. For example, the distribution destinations may be three or more. In this case, in the additional restoration method, the distributed data is added in the order of the distributed data numbers such as “distributed data 1+distributed data 2+distributed data 3”. Similarly, in the case of merging, insertion is performed in the order of distributed data numbers.

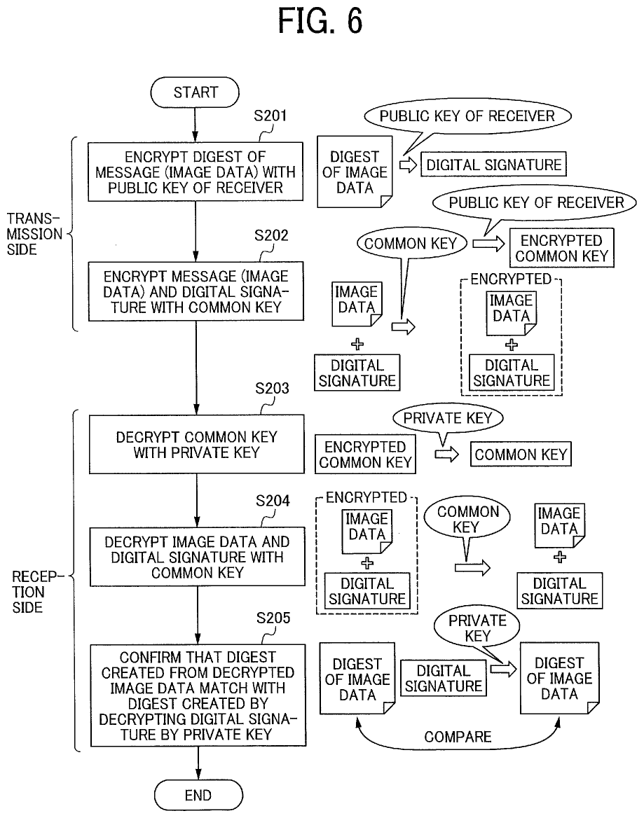

Hereinafter, a description is given of S/MIME with reference to FIG. 6. FIG. 6 is a diagram illustrating an outline of encryption and decryption processing by S/MIME. S/MIME is a standard for public key encryption and digital signature of email encapsulated in MIME.

In step S201, the transmission apparatus 10 encrypts the digest of the message (image data in the present embodiment) with the public key of the receiver. The encrypted digest is called a digital signature. The digest is an output obtained by applying a hash function to the message.

In step S202, the transmission apparatus 10 attaches a digital signature to the image data and encrypts the image data with the digital signature as a new message. The common key generated by the transmission apparatus 10 is used for encryption. The common key is encrypted with the public key of the receiver.

The image data encrypted with the common key and the electronic signature, and the common key encrypted with the public key are transmitted to the reception apparatus 30.

In step S203, the reception apparatus 30 decrypts the common key with the private key (distributed and stored in the present embodiment) corresponding to the public key of the reception apparatus 30. Thereby, the common key is obtained.

In step S204, the reception apparatus 30 decrypts the message (encrypted image data and electronic signature) with the common key. As a result, the image data and the electronic signature are obtained.

In step S205, the reception apparatus 30 creates a digest of the decrypted image data, compares the electronic signature with the digest decrypted with the private key, and confirms that the digests match. If the digests match, the reception apparatus determines that the image data has not been tampered with.

Note that S/MIME has been described in the present embodiment since the image data transmitted by internet fax or email is encrypted by S/MIME. If it is required to conceal even with an encryption method that uses a private key (public key encryption method) or a common key, the present embodiment can be preferably applied to a method of storing a private key or a public key.

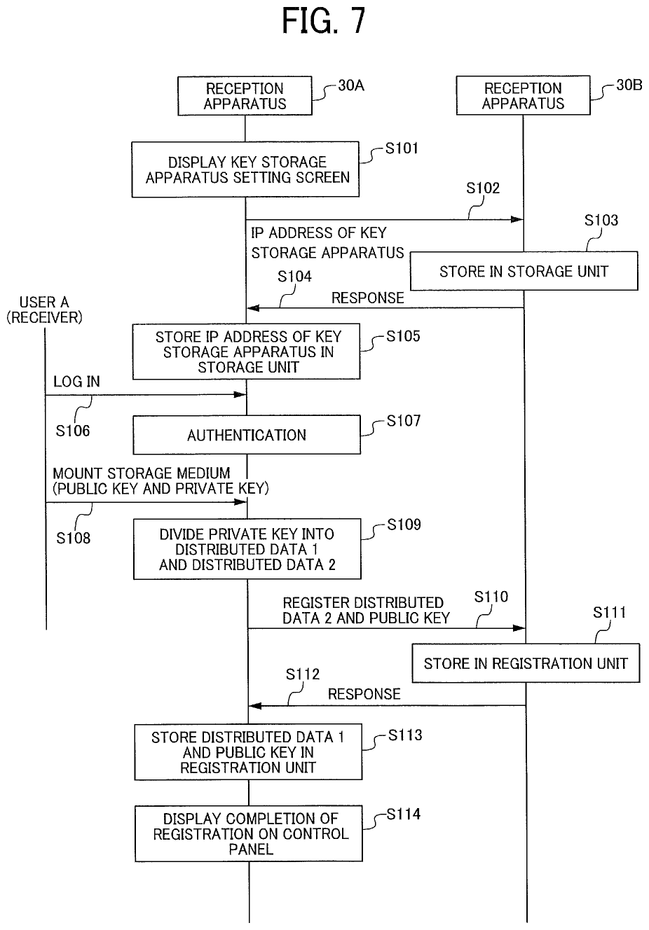

Next, a method in which a plurality of reception apparatuses 30 distribute and interpolate private keys is described with reference to FIG. 7. FIG. 7 is a sequence diagram illustrating an example of a process for registering a receiver's private key and public key in the reception apparatus 30.

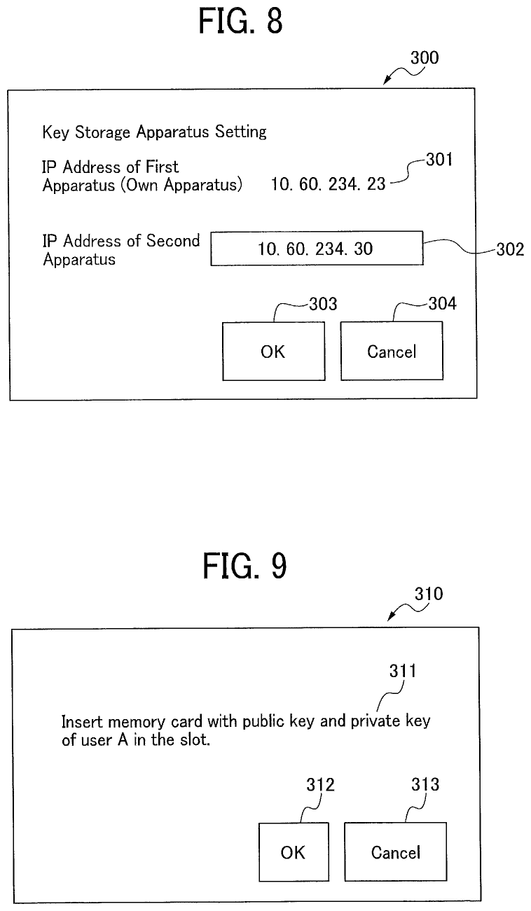

In step S101, the administrator operates the reception apparatus 30A to display the key storage apparatus setting screen on the control panel of the reception apparatus 30A. The key storage apparatus setting screen is for setting the reception apparatuses 30 to distribute and store the keys. An example of the key storage apparatus setting screen is illustrated in FIG. 8. As illustrated in FIG. 8, the administrator inputs the IP address of the reception apparatus 30B. Since the IP address of the reception apparatus 30A is known, the IP address is automatically displayed.

In step S102, the communication unit 31 of the reception apparatus 30A transmits the IP addresses of the reception apparatuses 30A and 30B to the reception apparatus 30B with the IP address input by the administrator as the destination. As a result, the reception apparatuses 30A and 30B store each other's IP addresses.

In step S103, the communication unit 31 of the reception apparatus 30B receives the IP addresses of the reception apparatuses 30A and 30B, and the registration unit 39 stores the IP address in the storage unit 49. As a result, the reception apparatus 30B also stores the IP address of the reception apparatus 30A that stores the private key in a distributed manner.

In step S104, when the IP address is stored, the communication unit 31 of the reception apparatus 30B transmits a response indicating that the IP address is registered to the reception apparatus 30A.

In step S105, when the communication unit 31 of the reception apparatus 30A receives the response, the registration unit 39 stores the IP addresses of the reception apparatuses 30A and 30B in the storage unit 49.

In step S106, user A, who is the receiver, registers his or her public key and private key in the reception apparatus 30A. The user logs in to the reception apparatus 30A to register his or her keys. The administrator may perform this work.

In step S107, the operation reception unit 40 of the reception apparatus 30A receives the identification information and the password of user A, and the authentication unit 32 determines whether the authentication is successful or unsuccessful. In the description of FIG. 7, it is assumed that the authentication is successful. When the authentication is successful, the display control unit 41 displays a message screen illustrated in FIG. 9 prompting the mounting of the storage medium on the operation panel.

In step S108, user A inserts the memory card (storage medium) containing the public key and the private key into the storage medium mounting unit 940c, and presses the OK button on the message screen, according to the message. The operation reception unit 40 receives the operation of the OK button.

In step S109, the division unit 38 of the reception apparatus 30A reads the private key from the storage medium and divides the private key. The storage medium stores a public key and a private key with a specific file name. In the present embodiment, since the data is divided into two, distributed data 1 and distributed data 2 are created. The first half (the data closer to the beginning when extracted one character at a time) is the distributed data 1, and the latter half (the data closer to the end when extracted one character at a time) is the distributed data 2.

In step S110, the communication unit 31 of the reception apparatus 30A transmits the user identification information, the public key, the distributed data 2, and the restoration method specified by logging in, to the reception apparatus 30B with the IP address of the reception apparatus 30B stored in the storage unit 49 as the destination.

In step S111, the communication unit 31 of the reception apparatus 30B receives the user identification information, the public key, the distributed data 2, and the restoration method, and the registration unit 39 stores the distributed data 2 and the restoration method in the distributed data storage unit 491 of the storage unit 49 in association with the identification information of the user. In addition, the registration unit 39 stores the public key in the public key storage unit 191 in association with the identification information of the user, in case the reception apparatus 30B becomes the transmission apparatus 10.

In step S112, the communication unit 31 of the reception apparatus 30B transmits to the reception apparatus 30A, a response indicating that the public key is stored.

In step S113, the communication unit 31 of the reception apparatus 30A receives the response, and the registration unit 39 stores the distributed data 1 and the restoration method in the distributed data storage unit 491 of the storage unit 49 in association with the user identification information. Further, in preparation for the case where the reception apparatus 30A becomes the transmission apparatus 10, the public key is stored in the public key storage unit 191 in association with the user identification information.

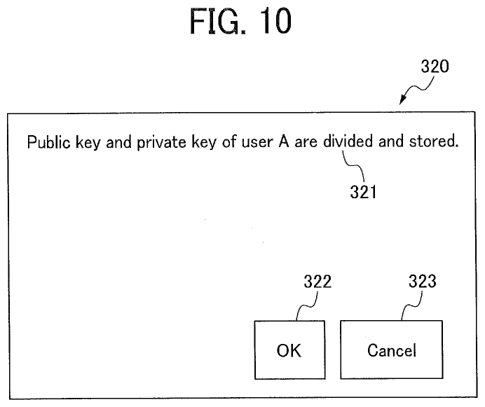

In step S114, when the distributed data 1 and the public key are registered, the display control unit 41 of the reception apparatus 30A displays a registration completion screen to notify user A that the registration is completed. An example of the registration completion screen is illustrated in FIG. 10.

FIG. 8 is a diagram illustrating an example of a key storage apparatus setting screen 300 displayed in step S101. The key storage apparatus setting screen 300 includes a first apparatus IP address display field 301 and a second apparatus IP address input field 302. Since the first reception apparatus 30A is an apparatus operated by the administrator, the IP address of the reception apparatus 30A is automatically displayed on the first apparatus IP address display field 301 together with the key storage apparatus setting screen 300. The administrator cannot change the IP address of the reception apparatus 30A. The second apparatus IP address input field 302 is a field in which the administrator sets the IP address of the reception apparatus 30B. The apparatus to be the reception apparatus 30B is already determined and the IP address of the reception apparatus 30B is known to the administrator.

When the IP address is input and the OK button 303 is pressed, the IP addresses of the reception apparatuses 30A and 30B in which the private keys are distributed and stored are determined. When the cancel button 304 is pressed, the key storage apparatus setting screen 300 is cleared without determining the IP addresses of the reception apparatuses 30A and 30B to store the private key.

FIG. 9 is a diagram illustrating an example of the message screen 310 that is displayed in step S107. The message screen 310 displays a message 311, “Insert memory card with public key and private key of user A into the slot.”, an OK button 312 and a cancel button 313. When user A inserts the storage medium into the storage medium mounting unit 940c and presses the OK button 312, the storage process of the private key and the public key starts. As indicated in the message, user A is identified by logging in, and only user A himself or herself can register the public key and private key.

FIG. 10 is a diagram illustrating an example of a registration completion screen 320. The registration completion screen 320 is a screen displayed on the control panel 940 when the storage process of the private key and the public key is completed. The registration completion screen 320 includes a message 321, “Public key and private key of user A are divided and stored.”, an OK button 322, and a cancel button 323. The registration completion screen 320 notifies user A that the storage has been completed.

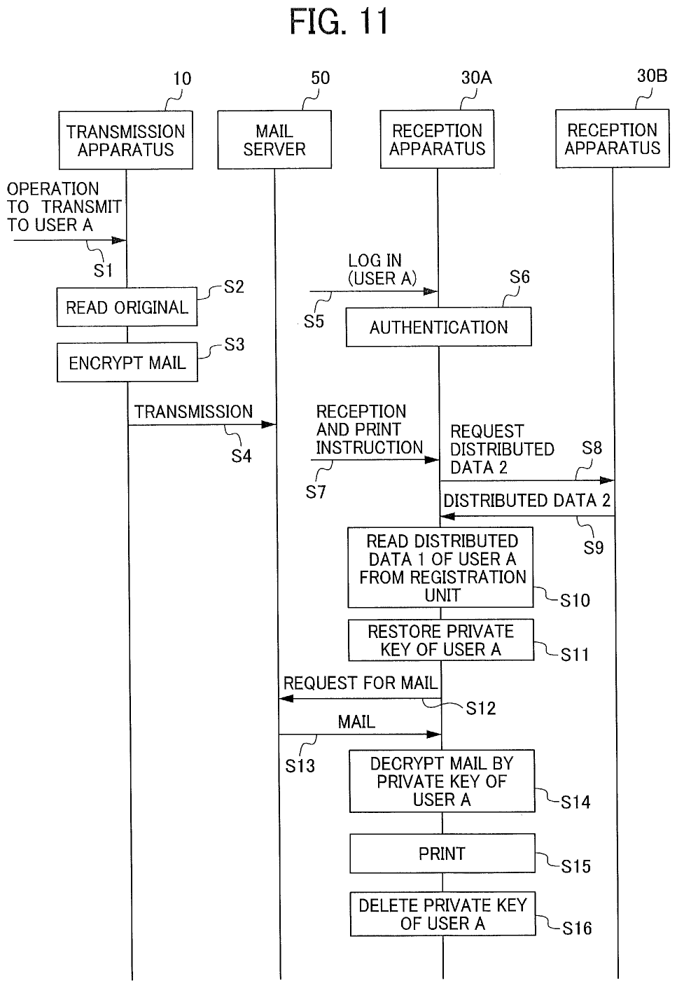

Next, a process executed by the reception apparatus 30 to decrypt image data by using the private key stored in the distributed manner is described with reference to FIG. 11. FIG. 11 is a sequence diagram illustrating a process executed by the reception apparatus 30 when receiving an encrypted email transmitted by the internet fax according to the embodiment.

In step S1, the sender activates an application and performs an operation of transmitting the document by internet fax. The sender places the original on exposure glass and designate the receiver's email address according to the instruction of the application. The operation reception unit 15 of the transmission apparatus 10 receives these operations.

In step S2, the reading unit 12 of the transmission apparatus 10 reads the original and creates image data.

In step S3, the encryption unit 13 of the transmission apparatus 10 encrypts the image data to be attached to the email according to S/MIME.

In step S4, the mail transmission unit 14 sends the email with the image data attached to the mail server 50 through the communication unit 11 to the receiver's mail 30 address as the destination.

In step S5, the receiver (user A) logs in to the reception apparatus 30A. The operation reception unit 40 of the reception apparatus 30 receives the identification information and password of the user.

In step S6, the authentication unit 32 performs authentication based on the user's identification information and password and determines whether the authentication is successful or not successful. In the description of FIG. 11, it is assumed that the authentication has succeeded.

In step S7, the receiver activates an application, and inputs an operation for receiving and printing the email addressed to him/herself sent by internet fax. The operation reception unit 40 of the reception apparatus 30 receives these operations.

In steps S8 and S9, in response to receiving the encrypted email, the acquisition unit 33 starts acquisition of the distributed data. The distribution destination information is acquired by referring to the distribution destination storage unit 492 based on the identification information of the logged-in user. Then, the distributed data 2 is requested by designating the user identification information to the reception apparatus 30B that is the distribution destination, and the distributed data 2 is acquired as a response to the request.

In step S10, the acquisition unit 33 refers to the distribution destination storage unit 492, determines that the reception apparatus 30A is also the distribution destination, and acquires the distributed data 1 associated with the user identification information from the distributed data storage unit 491.

In step S11, the restoration unit 34 restores the distributed data 2 received from the reception apparatus 30B and the distributed data 1 acquired from the distributed data storage unit 491 based on the restoration method. As a result, the private key of the receiver is restored.

In steps S12 and S13, the mail reception unit 37 transmits the account of the logged-in receiver to the mail server 50 through the communication unit 31, and receives the email addressed to the receiver. As described above, the image data attached to the email is encrypted by S/MIME.

In step S14, the decryption unit 35 decrypts the image data attached to the email with the restored private key of the receiver.

In step S15, the output unit 36 prints the decrypted image data on a sheet material such as paper. Thereby, the image data is safely transmitted by the internet fax and printed by the reception apparatus 30A.

In step S16, the restoration unit 34 deletes the receiver's private key in response to completion of printing. As a result, the entire private key of the receiver is prevented from remaining in one reception apparatus 30.

As described above, even if the information processing system 100 of the present embodiment includes the reception apparatus 30 shared by a plurality of users, the private key of the receiver can be safely stored at a low cost, and a message encrypted by S/MIME can be received with a reduced cost.

In the conventional internet fax, the email encrypted by S/MIME can be received by the PC. However, the merit of the reception apparatus 30 that can receive an internet fax without using a PC cannot be utilized. In the present embodiment, S/MIME encrypted email can be received with the reception apparatus 30.

When attempting to support S/MIME with a plurality of reception apparatuses 30, each reception apparatus 30 needs to store the private key, which increases the security risk or increases the cost of managing the private key. In the present embodiment, a plurality of reception apparatuses 30 can receive an S/MIME email at low cost.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

For example, one of the distributed data may not be stored in the reception apparatus 30 where the user has logged in. In this case, since the distribution destination storage unit 492 is included in each reception apparatus 30 or a server or the like with which the reception apparatus 30 can communicate, the reception apparatus 30 logged in by the user can also obtain each distributed data.

The configuration example of FIG. 5 in the above embodiments is divided according to the main functions in order to facilitate understanding of the processing of the information processing system 100. No limitation is intended by how the processes are divided or by the name of the processes. The processes implemented by the information processing system 100 can be divided to a larger number of processes depending on the contents of processes. Further, the processing unit may be divided so that one processing unit includes more processing.

Each function of the embodiments described above can be implemented by one or a plurality of processing circuitry. Processing circuit includes a programmed processor, as a processor includes circuitry. A processing circuit also includes apparatuses such as an application specific integrated circuit (ASIC), digital signal processor (DSP), field programmable gate array (FPGA), and conventional circuit components arranged to perform the recited functions.

The apparatuses described in the examples are merely an illustration of one of several computing environments for implementing the embodiments disclosed herein.

In an embodiment, the apparatuses in the mail server include plural computing devices, such as a server cluster. The plurality of computing apparatuses are configured to communicate with one another through any type of communication link, including a network, shared memory, etc., and perform the processes disclosed herein.

Further, the reception apparatus can be configured to share the disclosed processing steps, for example, FIG. 7 and FIG. 11, in various combinations. For example, a process executed by a given unit may be executed on any of the devices in the reception apparatus. The elements of the transmission apparatus 10 and the reception apparatus 30 may be combined into one server or may be divided into a plurality of apparatuses.

Note that the transmission apparatus 10 and the reception apparatus 30 are each not limited to an image forming apparatus as long as the apparatus includes a communication function. The transmission apparatus 10 and the reception apparatus 30 includes, for example, an output device such as a projector (PJ), an electronic whiteboard, a digital signage, a head up display (HUD) device, and an industrial machine, an imaging device, a sound collecting device, a medical device, a network home appliance, an automobile (connected car), a notebook PC, a mobile phone, a smartphone, a tablet terminal, a game console, a personal digital assistant (PDA), a digital camera, a wearable PC or a desktop PC.

What is claimed is:

1. A reception apparatus comprising:
at least one memory that stores a plurality of instructions; and
a processor that executes the plurality of instructions, configured to;
receive an encrypted email;
store, in the at least one memory, a part of a private key in association with identification information of a destination user of the email;
acquire a remainder of the private key from one or more other reception apparatuses that store the remainder of the private key;
restore the private key from the remainder of the private key and the stored part of the private key;
decrypt the email with the restored private key; and
output the decrypted email.

2. The reception apparatus of claim 1, wherein the processor is further configured to;
display on a display a message prompting to mount a storage medium storing a public key and the private key; and
when the storage medium storing the public key and the private key is mounted and an operation to start storing the public key and the private key is received, divide the private key into the part of the private key and the remainder of the private key.

3. The reception apparatus of claim 2, wherein the processor is further configured to;
display on the display an IP address of the reception apparatus and an input field for an IP address of the one or more other reception apparatuses; and
receive the IP addresses of the one or more other reception apparatuses in the input field.

4. The reception apparatus of claim 1, wherein
the processor is further configured to;
request the one or more other reception apparatuses for the remainder of the private key in response to receiving the email; and
receive the remainder of the private key transmitted in response to the request.

5. The reception apparatus of claim 4, wherein
the processor is further configured to;
request the one or more other reception apparatuses for the remainder of the private key based on identification information of the user used in logging in to the reception apparatus.

6. The reception apparatus of claim 1, wherein the processor is further configured to;
decrypt the email with secure multipurpose internet mail extensions (S/MIME) using the restored private key, wherein the email is encrypted with S/MIME.

7. An information processing system comprising:
a transmission apparatus including:
at least one first memory that stores a plurality of instructions; and
a first processor that executes the plurality of instructions, configured to;
read a document to generate image data;
encrypt the image data; and
transmit an email attached with the encrypted image data; and
a reception apparatus including:
at least one second memory that stores a plurality of instructions; and
a second processor that executes the plurality of instructions, configured to;
receive the email from the transmission apparatus;
acquire, from the at least one second memory, a part of a private key that is associated with identification information of a destination user of the email;
acquire a remainder of the private key from another reception apparatus that stores the remainder of the private key;
restore the private key from the acquired remainder of the private key and the stored part of the private key;
decrypt the email with the restored private key; and
output the decrypted email.

8. A reception method comprising:
receiving an encrypted email;
acquiring remainder of a private key from one or more other reception apparatuses that store the remainder of the private key;
restoring the private key from the acquired remainder of the private key and a part of the private key stored in association with identification information of a destination user of the email;
decrypting the email with the restored private key; and
outputting the decrypted email.
